(19) United States
(12) Patent Application Publication
(10) Pub. No.: US 2007/0059143 A1
(43) Pub. Date: Mar. 15, 2007

(54) Tow truck motorcycle dolly and accessory boxes

(76) Inventor: John A. Woodward, Orangevale, CA (US)

Correspondence Address: Michael F. Krieger;KIRTON & McCONKIE, Suite 1800, 60 East South Temple, Salt Lake City, UT, 84111, US

(21) Appl. No.: 11/224,425

(22) Filed: Sep. 12, 2005

(51) Int. Cl. B60P 3/12

(52) U.S. Cl. 414/563; 280/402

(57) ABSTRACT

The present invention related to various accessories, which may be utilized in tow truck operations. In particular, the present invention relates to a motorcycle tow dolly which allows a single operator to efficiently and safely load a motorcycle onto the bed of a flatbed tow truck and to an accessory box system which may be utilized to store accessories associated with tow truck operations.

### FIELD OF THE INVENTION

The present invention related to various accessories, which may be utilized in tow truck operations. In particular, the present invention relates to a motorcycle tow dolly which allows a single operator to efficiently and safely load a motorcycle onto the bed of a flatbed tow truck and to an accessory box system which may be utilized to store accessories associated with tow truck operations.

### BACKGROUND AND RELATED ART

The following invention relates to a tow dolly and a vehicle tool box, both of which may be utilized in tow truck operations. Various tow truck accessories have been provided for use in relation to two truck operations. However, several deficiencies for these tools presently exist. For example none of the prior art accessories allows a single operator to load a motorcycle onto the back of a flatbed tow truck without the assistance of an additional operator. Prior art variations for loading a motorcycle onto the back of a flatbed tow truck involve at least two operators. For example, some present systems require one operator to stabilize the motorcycle while another operator operates the tow truck controls. Accordingly, the ability to efficiently load motorcycles onto the back of flatbed a tow truck is desirable.

Another deficiency relates to the use of tool boxes which contain the accessories necessary to carry out a tow truck operation. For example, prior art tool boxes have been disclosed which attach to the body of a pickup truck or other vehicle. However, the prior art boxes fail to disclose systems which allow for convenient access to tools which have been separated into partitioned units. Additionally, prior art tool boxes fail to provide an air-tight and water-tight barrier between the outside of the box and the interior tool elements. Accordingly, it is desirable to produce a tow truck tool accessory box which may be attached to a tow truck which allows for convenient access to appropriately separated tools and protects the tools from the harsh exterior elements.

### SUMMARY OF THE INVENTION

The present invention relates to accessories that may be utilized in tow truck operations. Specifically, some embodiments of the present invention relate to motorcycle dollies which may be utilized to efficiently load a motorcycle onto the back of a flatbed truck with only one operator present. Other embodiments of the invention relate to accessory boxes which may be attached to a tow truck which allow for easy access and appropriate compartmentalization of tools and accessories associated with the use of a tow truck.

In some embodiments of the present invention the motorcycle dolly is comprised of a cradle for receiving a wheel 8 of a motorcycle 10. In some embodiments the cradle is connected to a stabilization bar system 6. In some embodiments, the stabilization bar system may be a multi-piece system comprised of two stabilization bars 12, 14 coupled to an attachment system 16 which couples to the cradle 4. In other embodiments of the tow dolly system, the stabilization system 6 may further comprise wheels 18. In other embodiments, the cradle may also comprise one wheel or two wheels 20. In other embodiments of the invention, the tow dolly may be further comprised of a means for connecting to a cable associated with a flatbed tow truck allowing the tow dolly with attached motorcycle 10 to be pulled onto the flatbed of a tow truck 1.

In some embodiments of the invention, an accessory box 50 may be comprised of multiple accessory boxes comprising accessory boxes located between the bed of the truck and the cab of the truck 53, and a plurality of boxes located below the plane created by the bed of the truck 54a, 54b, and 54c. The boxes 53, 54a-54c of the invention may in some embodiments be comprised of a latching/locking apparatus 56. Some embodiments of the invention are comprised of a chamber defined by the box and a door 58 operable connected to said box. In some embodiments a box may be further comprised of a drawer 60 slideably mounted to the interior of a box. In some embodiments, the invention may be further comprised of a partition system 62 which allows the space in a drawer to be segregated into a functionally separated partition system 62. In other embodiments of the invention, the box system 50 may be additionally comprised of a fixed partitioned top shelf 64 which utilizes the bottom of the tow truck bed 3 as a door to close the top of the fixed partitioned top shelf 64.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 depicts an embodiment of the motorcycle tow truck dolly of the present invention;

FIG. 2 depicts a side view of two embodiments of the motorcycle dolly of the present invention;

FIG. 3 depicts an embodiment of the motorcycle dolly of the present invention, particularly depicting the first and second stabilization bars separated from the attachment system;

FIG. 4 depicts an embodiment of the motorcycle dolly of the present invention;

FIG. 5 depicts an embodiment of a locking system utilized to attach a stabilization bar to the attachment system which attaches the stabilization system to the cradle;

FIG. 6 depicts an embodiment of an accessory box system described in this invention attached to a tow truck wherein the accessory boxes are in a closed position;

FIG. 7 depicts an embodiment of the accessory box system of the present invention wherein the boxes depicted are open and the accessory drawers are moved to a forward access position;

FIG. 8 depicts an embodiment of an accessory box separated from a tow truck, and particularly depicts the storage space created by the fixed partitioned top shelf of some embodiments of the storage accessory box system;

FIG. 9 depicts an embodiment of the accessory box system coupled to the frame of a tow truck;

FIG. 10 depicts several elements of an attachment means which may be utilized in some embodiments to attach the accessory box system to the frame of a tow truck; and

FIG. 11 depicts a preferred embodiment of a tunnel box.

### DETAILED DESCRIPTION OF THE INVENTION

The present invention relates to various accessories which may be utilized with a tow truck. In particular, the invention relates to various embodiments of a motorcycle dolly for loading a motorcycle onto the flatbed of a tow truck utilizing only one operator, and various accessory storage systems to be utilized in conjunction with tow truck operations. The following disclosure of the present invention is grouped into subheadings. The utilization of the subheadings is for convenience of the reader only and is not to be construed as limiting in any sense.

1. Motorcycle Dolly

The following sets forth and present various embodiments of a motorcycle dolly system which may be utilized for to move a motorcycle from the street onto the back of a tow truck or other vehicle. These examples are not intended to be limiting in any way, but are merely illustrative of the benefits and advantages of utilizing embodiments of the present invention.

Some embodiments of the present invention comprise a motorcycle tow dolly 2 which may be utilized to load a motorcycle 10 onto the flatbed 3 of a tow truck 1. In some embodiments of the present invention, only one operator is required to load the motorcycle 10 onto the flatbed of a tow truck 3. Accordingly, some embodiments of the present invention relate to a system for attaching a motorcycle 10 to a motorcycle tow dolly 2 which has the capacity to hold a motorcycle in an upright position, allowing an operator to move the motorcycle onto the flatbed of the truck 3 without having to simultaneously stabilize the motorcycle being loaded onto the flatbed of the truck 3. For the sake of clarity this description is primarily focused on a tow dolly system that may be utilized in tow truck operations. However, the present invention contemplates utilizing the dolly in a variety of applications. For example the tow dolly of the present invention may be utilized to move a motorcycle from the road into the back of a pick up truck.

Some embodiments of the tow dolly of the present invention are comprised of a cradle 4 which may be utilized to hold or cradle the front wheel of a motorcycle 10. The cradle 4 in some embodiments is coupled to a stabilization bar system 6 which may be comprised of one or more system elements. In preferred embodiments of the stabilization bar system 6, the stabilization bar system 6 is comprised of a first stabilization bar 12 and a second stabilization bar 14, and an attachment system for attaching the stabilization bars to the cradle of the motorcycle tow dolly 2. In preferred embodiments of the present invention, the first and second stabilization bars 12, 14 are attached to the attachment system 16 by a locking system 22. The locking system 22 may be one of a variety of locking means including, but not limited to, a set screw, a bolt and nut, a locking pin system, or other means known in the art for attaching one implement with each other.

In some embodiments of the present invention, the stabilization bar system 6 is further comprised of a means for attaching 24 the handlebars of a motorcycle 11 to the stabilization bar system 6. In preferred embodiments of the present invention, the attachment means is comprised of an eye-bolt 24 coupled to the end of a stabilization bar 6. Accordingly, a preferred embodiment of the present invention, the motorcycle front tire 8 may be placed into the cradle 4, and each handlebar of a motorcycle 11a and 11b may be attached or coupled to an attachment means 24, preferably an eye-bolt 24 of the stabilization bar system 6. Once the motorcycle front wheel is placed in the cradle 4 and the handlebars 11a and 11b are coupled to the attachment means 24, the motorcycle is held in an erect position and does not require an attending operator to prevent the motorcycle from tipping over.

In some embodiments the motorcycle dolly of the present invention may further comprise wheels 18A, 18B attached to the stabilization bar system 6. The present invention contemplates various means for allowing the cradle 4 and stabilization bar system 6 of the present invention to be moved across the ground and onto the back of a tow truck flat bed 3, including but not limited to wheel(s), bearings or sled-type systems for sliding the stabilization system across the flat surface.

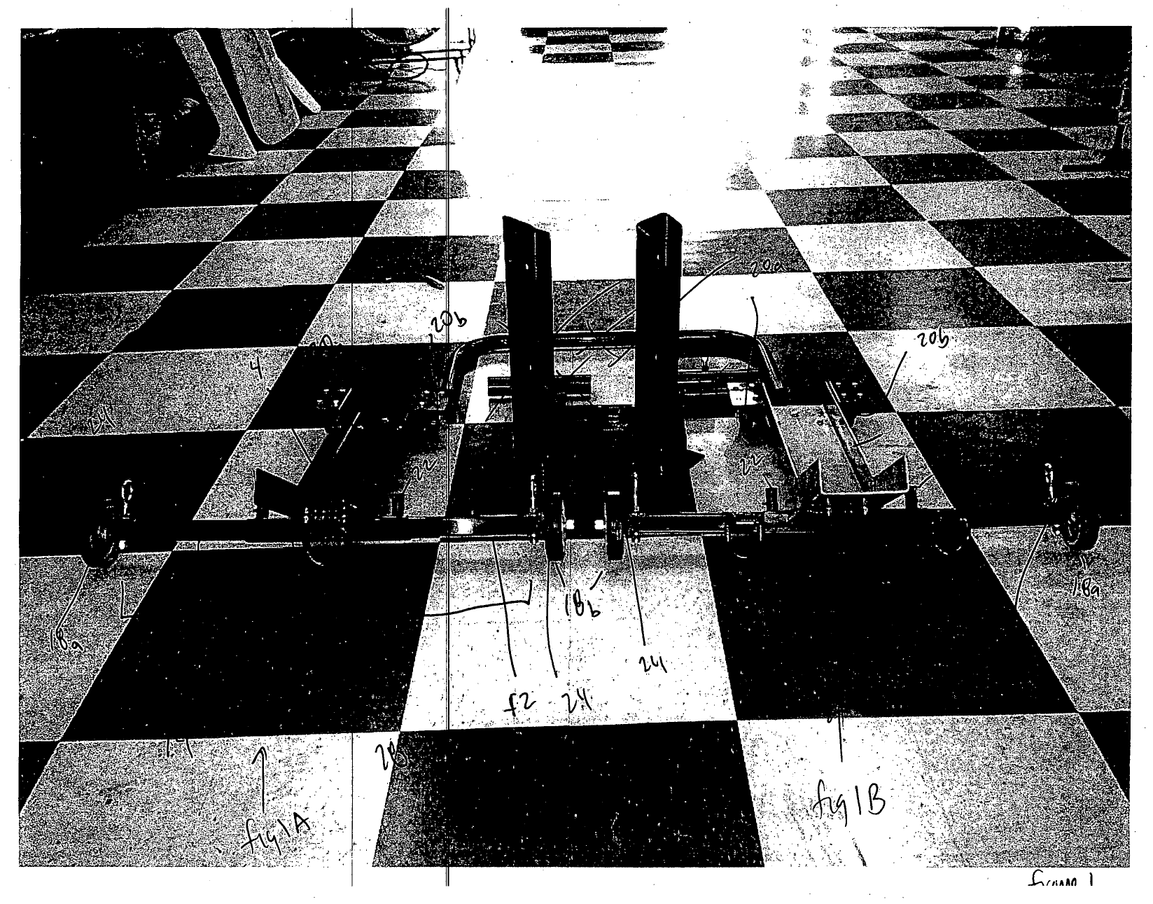

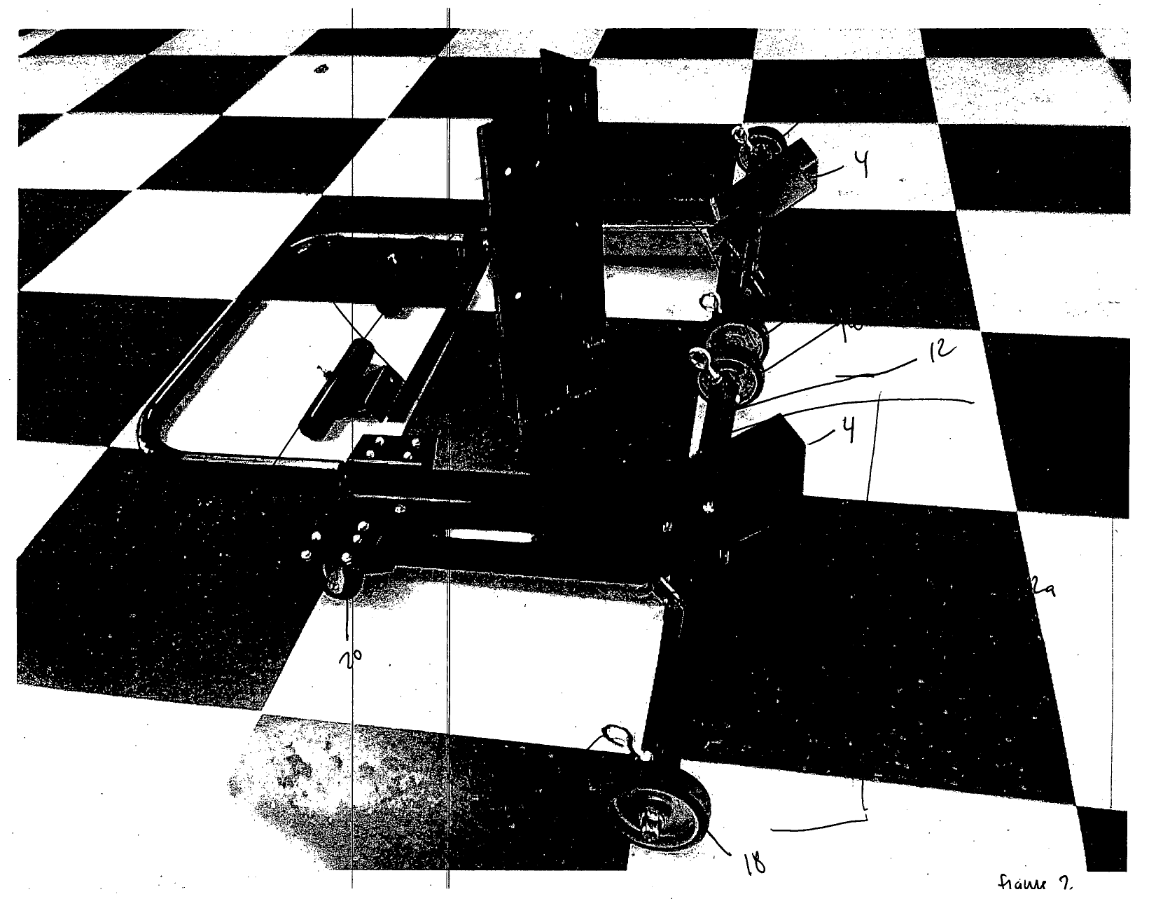

Some embodiments of the invention are further comprised by one or more cradle wheels 20A, 20B as depicted in FIG. 1D. Some embodiments of the dolly system 2 are comprised of two wheels coupled to the end of the cradle. In some embodiments the combination of the stabilization bar wheel(s) 18 and the cradle wheel(s) 20 allows the dolly to move easily across flat or inclined surfaces when pulled or pushed in a given direction while maintaining a motorcycle in an erect position.

Some embodiments of the present invention comprise a means for attaching a tow dolly to a cable or winch system which may be utilized to move a motorcycle from the road onto the bed of a tow truck or other vehicle. The attachment means 26 for coupling the tow dolly 2 to a cable rope or other device for moving the tow dolly onto the back of a flat bed tow truck or other vehicle may be comprised of one or more rings, quick-locking devices or appendages that serve as a means for attaching a cable to the tow dolly 2. In preferred embodiments of the present invention the attachment means is comprised of one or more “D” shaped rings 28. As depicted in FIG. 1A the tow dolly in some embodiments is comprised of one D-ring 28 coupled to the center of the stabilization bar system 6 and allows a cable/chain/rope to be attached to the front of the stabilization bar system 6 and allows an operator remotely to control a winch system connected to the flat bed 3 of a tow truck 1 to move the tow dolly 2 containing an erect and stabilized motorcycle 10 onto the flat bed of the truck or other vehicle.

Alternatively depicted in FIG. 1B is an attachment means 26 comprised of two D-rings 28A and 28B, both coupled to the stabilization bar system but separated by a distance. Accordingly, the present invention contemplates utilizing one, or more than one attachment means for attaching the tow dolly 2 to a cable or like structure for moving the tow dolly 2 onto the back of a flatbed 3 of a tow truck or other vehicle.

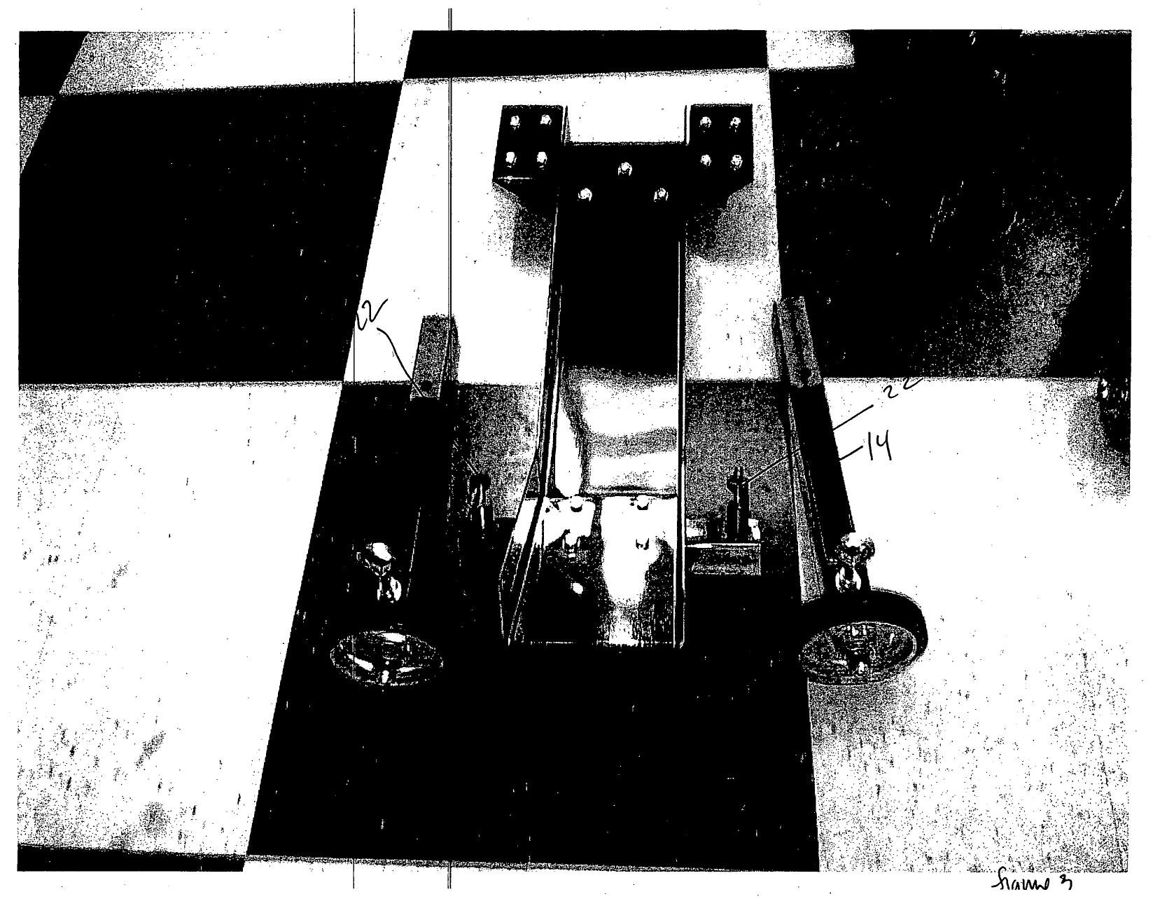

FIG. 2 depicts the side view of some embodiments of the present invention. FIG. 2 illustrates the relationship of various components of preferred embodiments of the present invention. As seen in FIG. 2, a preferred embodiment of the present invention is comprised of a cradle 4 and a stabilization bar system (6). In some embodiments of the invention, the stabilization bar system 6 is comprised of a first 12 and second 14 stabilization bar coupled to an attachment system 16 which couples the stabilization bar system 6 to the bottom of the cradle 4.

As depicted in FIG. 2, preferred embodiments of the present invention may further comprise a locking system 22A 22B which locks the first stabilization bar 12 and second stabilization bar 14 to the attachment system 16. Some embodiments further comprise eye bolts 24, or other attachment means, allowing the handle bars of a motorcycle 11 to be secured to the stabilization bar system 6.

As depicted in FIG. 2, preferred embodiments of the present invention further comprise a system of wheels coupled to various points of the motorcycle tow dolly which allow the motorcycle tow dolly to be moved across flat or inclined surfaces easily. For example, some embodiments are comprised of two wheels coupled to the ends of the stabilization bar system 18 and two wheels coupled to the end of the cradle 20. The present invention contemplates various wheel configurations which would allow the tow dolly of the present invention to be moved easily across flat or inclined surfaces. The present invention contemplates the use of one of more wheels attached to the stabilization bar system 6 and contemplates the use of one or more wheels to the cradle 4.

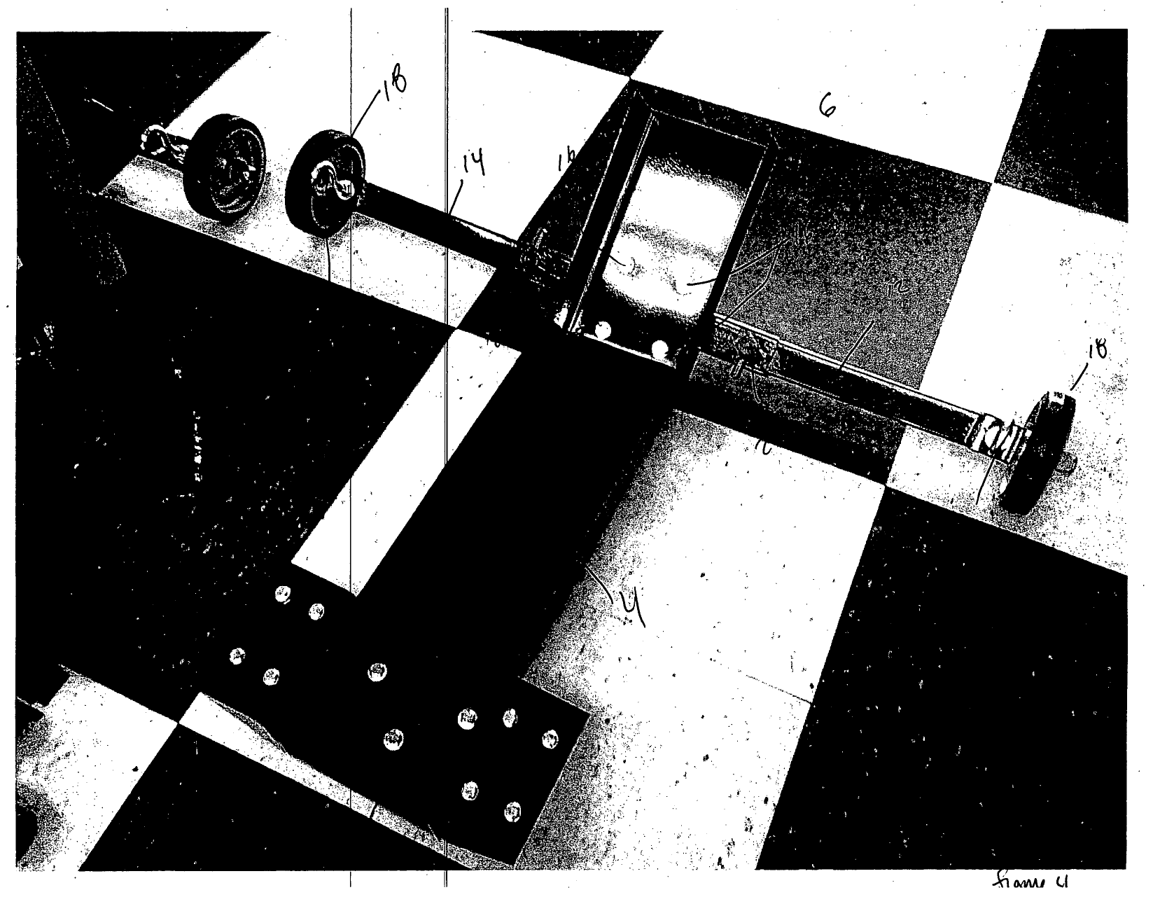

FIG. 3 depicts a preferred embodiment of the present invention wherein the first stabilization bar 12 and second stabilization bar 14 have been disconnected from the attachment means 26 of the stabilization bar system 6. Accordingly, in some embodiments, the stabilization bar system 6 of the present invention is comprised of various elements, including a first stabilization bar 12 which may be removably coupled to the attachment means system 16 and a second stabilization bar 14 which may also be removably connected to the attachment system 16. As depicted in FIG. 3, the locking system 22 has been moved into an unlocked position allowing the first and second stabilization bars 12 and 14, to be detached from the tow dolly system. Because the stabilization bars of the presently depicted invention may be removed, the embodiment depicted in FIG. 3 allows for convenient storage of the tow dolly apparatus.

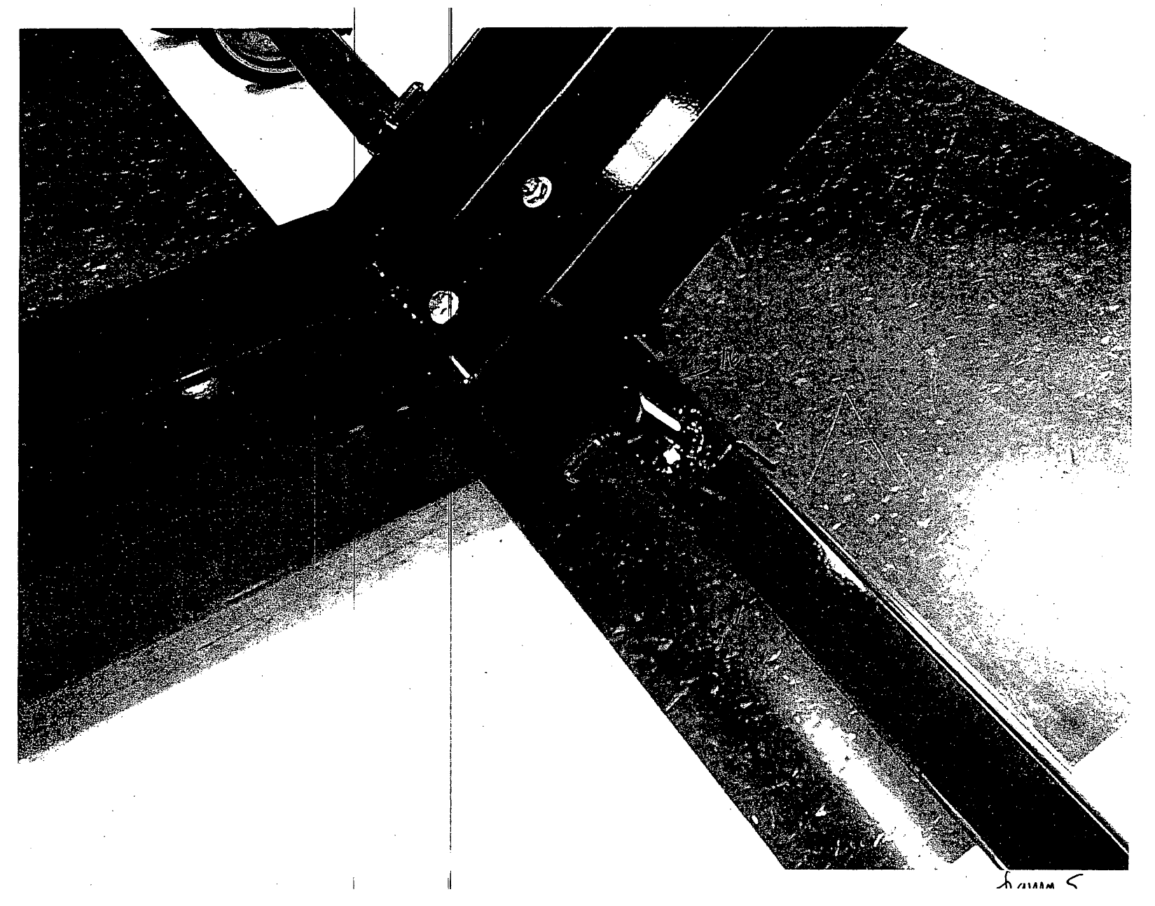

FIG. 4 additionally depicts a rear view of the tow dolly of the present invention comprising various elements associated with preferred embodiments of the present invention including a cradle 4, stabilization bar system 6, a first stabilization bar 12, a second stabilization bar 14, an attachment system 16, stabilization bar wheels 18, locking system 22 for securing the stabilization bars to the attachment systems, and eye-bolts, 24.

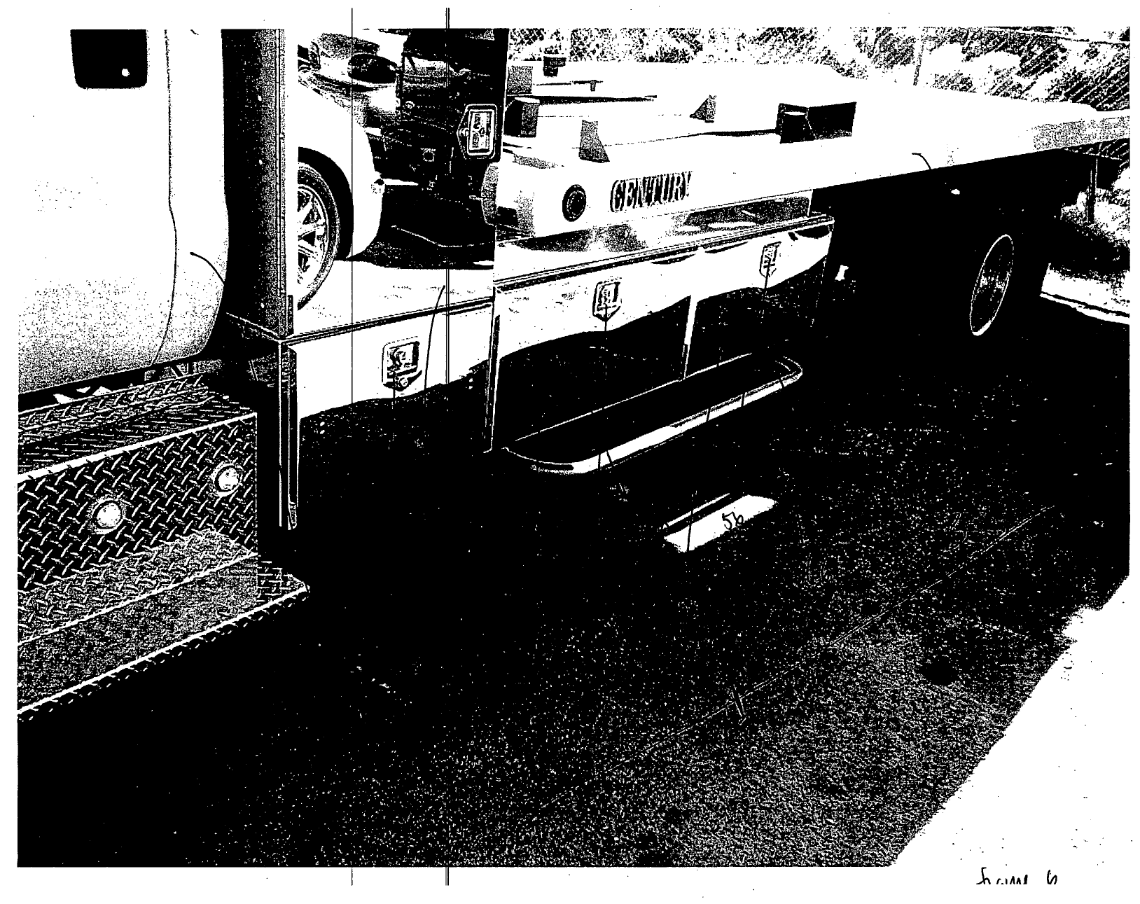

FIG. 5 provides a close-up view of an embodiment of a locking system 22 that may be utilized to lock the first and/or second stabilization bars 12, 14 to the attachment system 16. As depicted in FIG. 5 the preferred embodiments of the invention is comprised of a lever which may be rotated to move the locking system 22 into a locked or unlocked position allowing the first and/or second stabilization bars 12, 14 to either be in a locked or unlocked position.

2. Accessory Boxes

The following sets forth and present various embodiments of accessory box systems which may be utilized for the storage and compartmentalization of tools associated with tow truck operations. These examples are not intended to be limiting in any way, but are merely illustrative of the benefits and advantages of utilizing embodiments of the present invention.

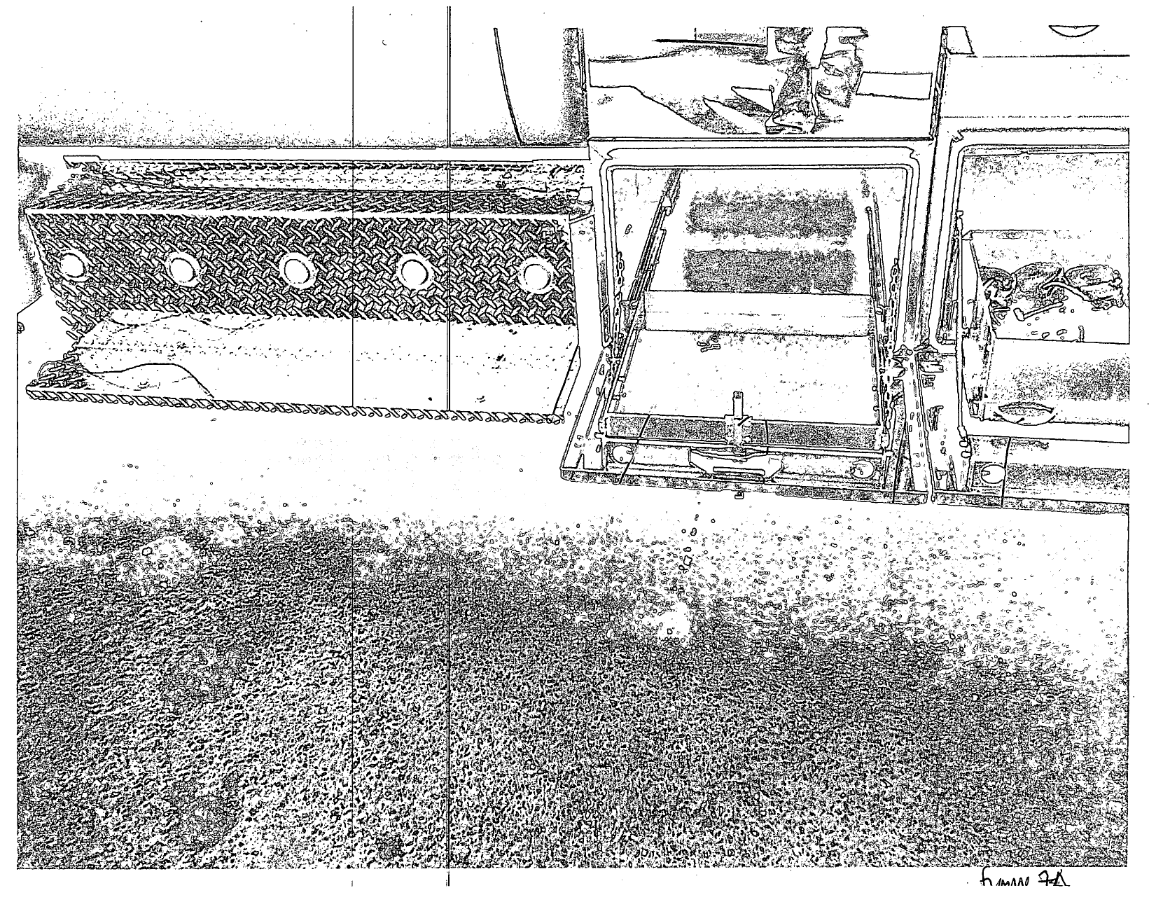

FIG. 6 depicts an embodiment of the accessory box system of the present invention. FIG. 6 depicts multiple independent boxes which constitute the accessory box system. One of the boxes depicted in FIG. 6 is a box located above the plane of the flat bed truck behind the cab of the truck (5), in some embodiments this box is referred to as a “tunnel box”. Additionally depicted are several boxes which are located below the plane of the bed of the truck (3). The present invention contemplates the use of one or more boxes in an accessory box system. Accordingly, the depiction in FIG. 6 is exemplary and is merely intended to illustrate a preferred embodiment of the invention. The present invention contemplates the use of 1 box, 2 boxes, 3 boxes, 4 boxes, 5 boxes, 6 boxes, 7 boxes, 8 boxes, 9 boxes, 10 boxes and/or more than 10 boxes depending on the needs of a particular tow truck operation.

Additionally the present invention contemplates attaching the accessory box system to other types of vehicles including semi-trucks, pickup trucks and or other appropriate automobiles or apparatus which may be used to move the accessory box system of the present invention from one geographic location to another. Accordingly the presently depicted accessory box system has the benefit of mobility and allows an operator to conveniently store and transport the tools needed to accomplish a task from one geographic location to another.

FIG. 6 further depicts elements of some embodiments of the accessory box system including a locking apparatus 56, a door 58 and a step 66.

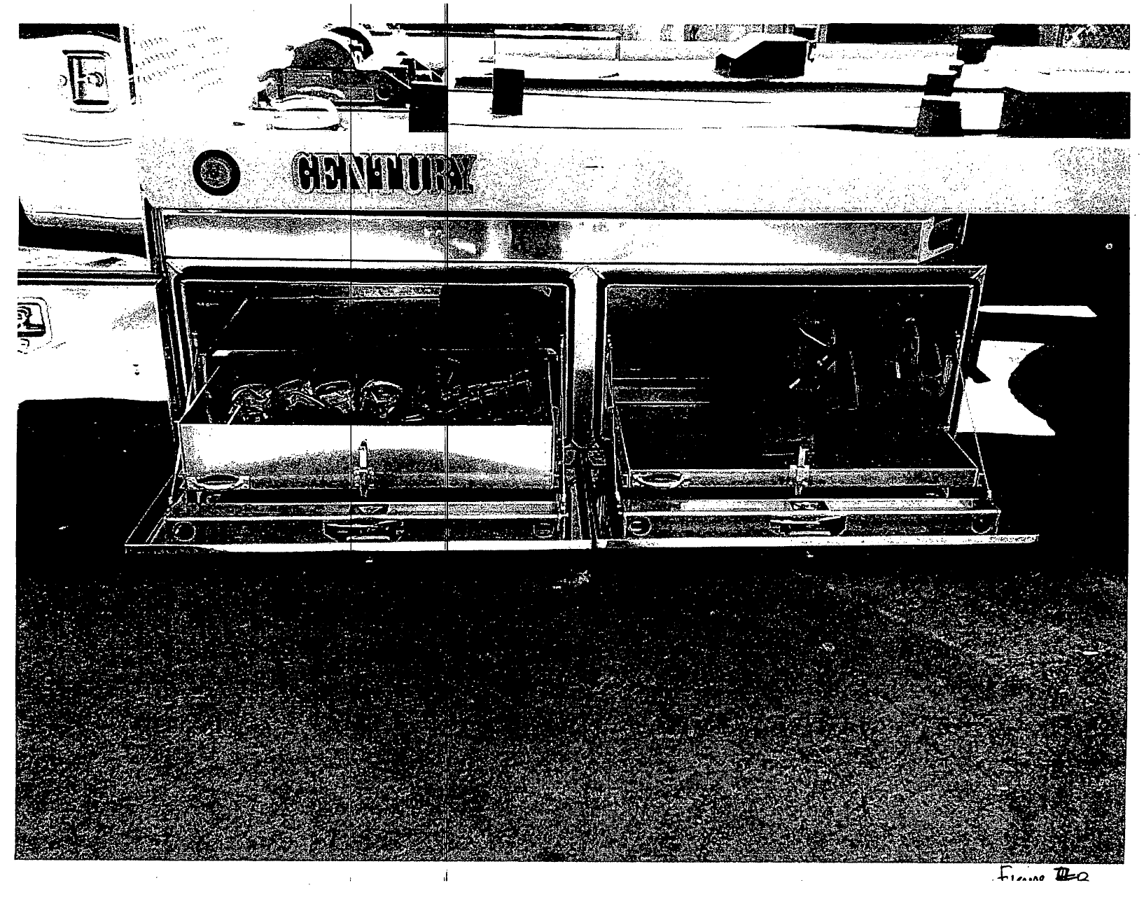

FIG. 7 depicts various elements of a preferred embodiment of the accessory box system of the present invention. In particular, FIG. 7 illustrates a preferred embodiment of the accessory box system 50 wherein the door 58 is in an open position on various boxes and the drawer located inside the box has been slid through the opening created by the open door 58. As depicted in FIG. 7 the slideable drawer 60 and door system 58 are comprised of various elements in a preferred embodiment of the present invention. In some embodiments the slideable drawer 60 is coupled to a slide system 62, which allows the drawer to slide in and out of the box when the door 58 is in an open position. In some embodiments, the door system is further comprised of a chain/cable and/or rope 68 which couples the door 58 to the interior of the box providing structural support to the door 58, which may serve as a platform.

As depicted in FIG. 7 various features may, in some embodiments, be coupled to the slideable drawer 60 including a locking means 70 and/or a handle 72. The locking means may be utilized to lock the drawer in an open or closed position preventing the drawer from moving indiscriminately while the tow truck is at rest, being operated or driven from one geographic location to another. The handle 72 coupled to the drawer may be utilized to more easily slide the slideable drawer 60 in and out of the box 53, 54 a-c.

FIG. 7 additionally depicts elements available in some embodiments of the present invention including weather stripping 74 and a “C” shaped channel 76. The combination of the weather stripping 74 and C-channel 76 of the accessory box system seals against the interior surface of a door 58, providing an airtight and watertight seal, preventing exterior elements, including moisture, from entering into the tool box area. Accordingly, in some embodiments of the present invention the tools or other items stored inside the accessory box system are contained in an area of box which is secure from any elements which may be detrimental to the contents of the box.

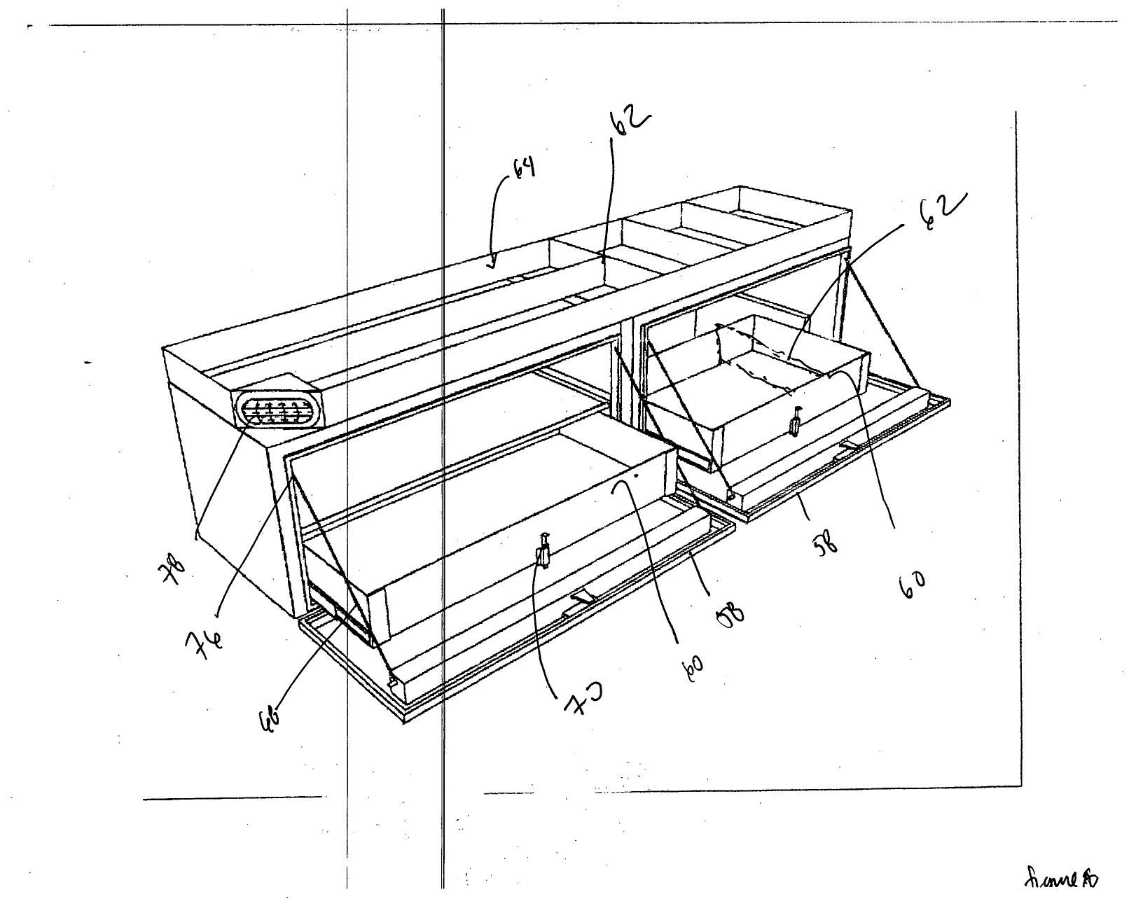

FIG. 8 depicts elements present in some embodiments of the accessory box system of the present invention including a door 58, a drawer 60, a partition system 62, a fixed partition top shelf 64, a chain or cable 68 a locking means 70, a C-channel 76 and a light 78.

FIG. 8 depicts an embodiment of an accessory box system 50 separated from a tow truck or other mobile device. FIG. 8 depicts various elements of the accessory box system previously depicted and makes readily accessible to the view additional components of some embodiments of the accessory box system. In particular, FIG. 8 highlights the fixed partition top shelf 64, present in some embodiments of the invention. In some embodiments of the invention the fixed partition top shelf 64 is comprised of various areas separated by partitions. The area may be partitioned into various shapes to accommodate differing types of tools utilized in different types of operations.

In some embodiments the accessory box system 50 is comprised of a fixed partition top shelf 64, which has been partitioned into separate areas. In preferred embodiments the fixed partition top shelf is divided, as depicted in FIG. 8, into five distinct compartments/areas. The present invention contemplates separating the fixed partitioned top shelf into one area, two areas, three, areas, four areas, five areas, six areas, seven areas, eight areas, nine areas, ten areas and more than ten areas as need dictates. In some embodiments the fixed partition top shelf 64 does not comprise a lid or a covering device, but instead utilizes the bed of the tow truck 3 as a lid. Accordingly, when the bed of the tow truck 3 is raised to an inclined position, the area contained within the fixed partition top shelf 64 is exposed and an operator may store or remove accessories or implements stowed in the fixed partition top shelf 64. When the tow truck bed 3 is lowered into a position parallel with the ground the contents of the fixed partition top shelf 64 are not accessible and are secured into place by the tow truck bed sealing against the top surface of the fixed partition top shelf.

Additionally depicted in FIG. 8 is a light (78) located at the corner of the fixed partition top shelf. In some embodiments of the present invention the light is placed at this location to provide additional safety features, allowing the operator to operate safely and efficiently in high traffic areas.

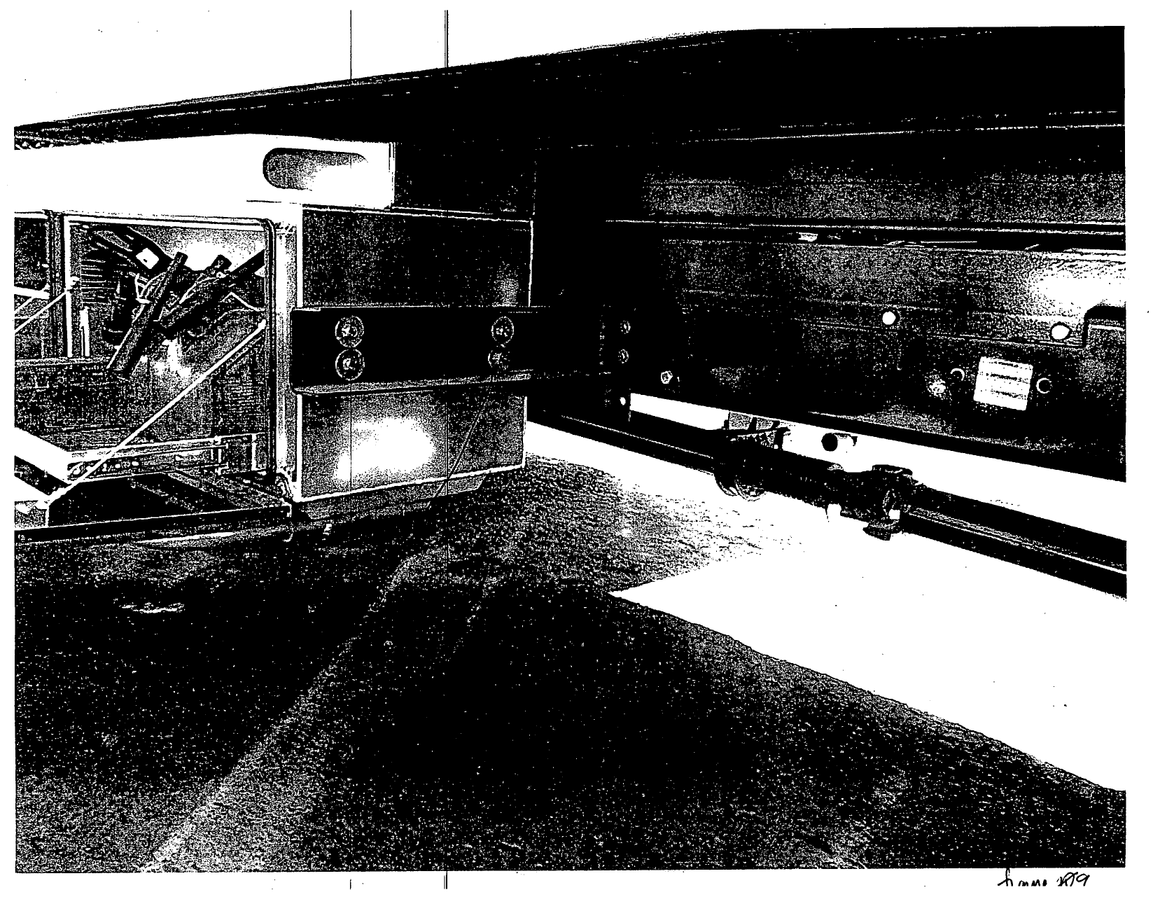

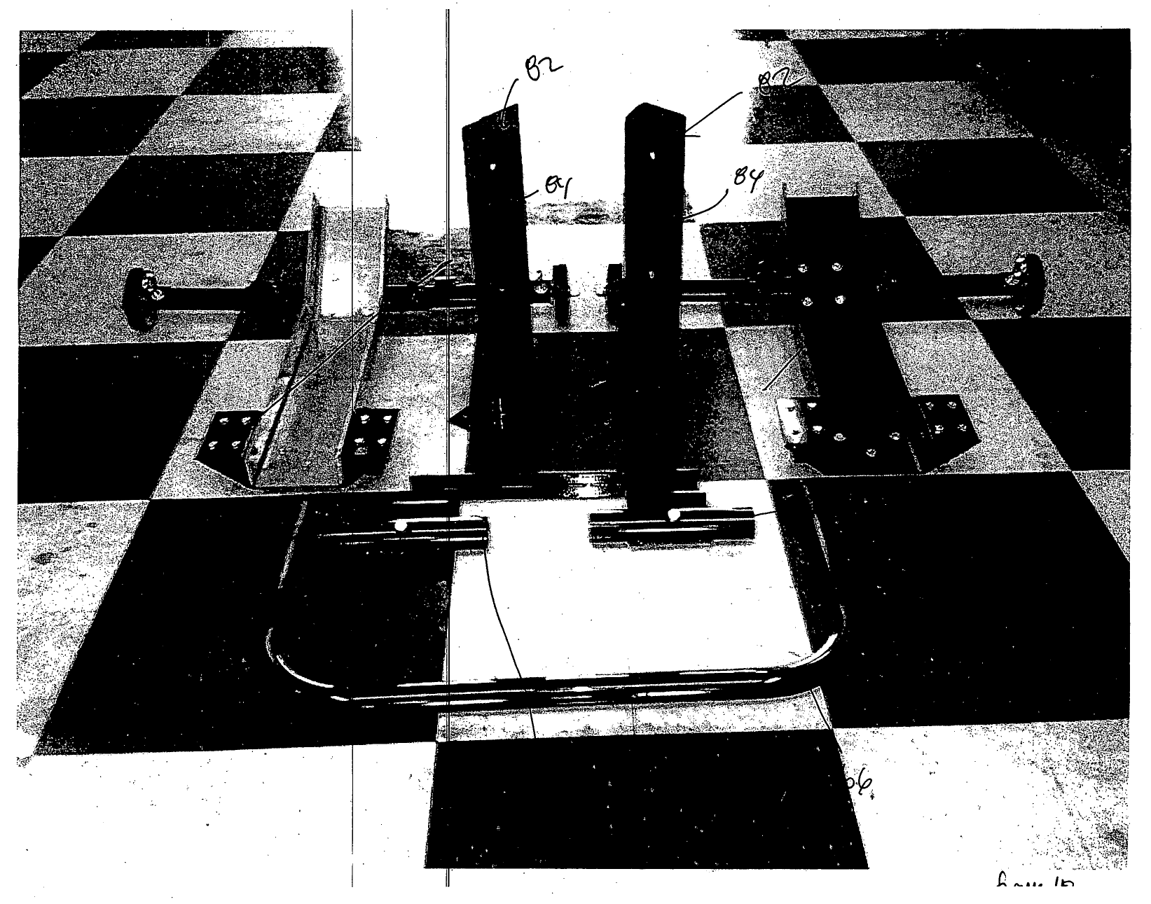

FIG. 9 and FIG. 10 illustrate the means for attaching the accessory box system of the present invention to the frame of a tow truck or other mobile device. In particular, FIG. 9 depicts an embodiment of the attachment means 82, which may be utilized to attach the accessory box system to the frame of the tow truck or other vehicle. In some embodiments of the attachment means 82, the attachment means 82 is comprised of two support bars 84, each of which may be attached both to the frame of the mobile device and to the exterior of the accessory box system. The attachment means may further be comprised of a step system 66 which may be attached to the bottom of the accessory box system.

As depicted in FIG. 9 and FIG. 10, the step 66 in some embodiments is a tube which may be made from various metals and/or other composite materials. In some embodiments the step 66 is suitable for supporting the weight of an operator. In some embodiments the tube of the step may be inserted into a step receptacle 67, which may be attached to the exterior of the accessory box system. As depicted in FIG. 9, the step and step receptacle may be coupled to the bottom of an accessory box system.

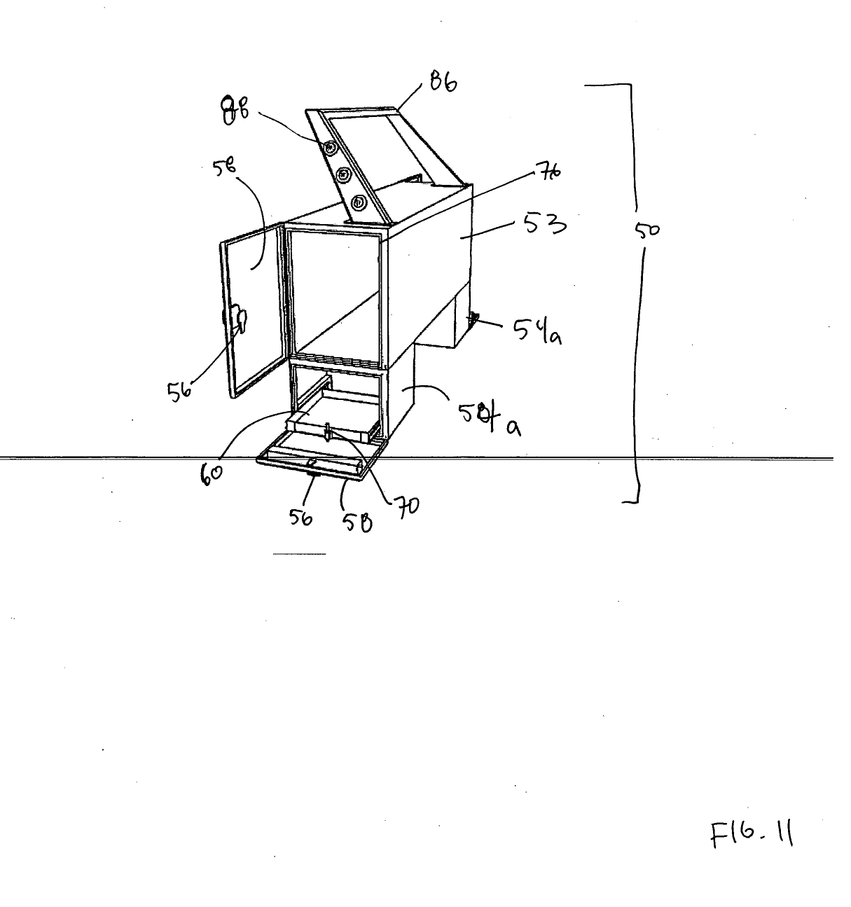

FIG. 11 depicts an embodiment of an accessory box system 50 of the present invention. As depicted in FIG. 11, some embodiments of the accessory box system 50 are comprised of a “tunnel box” 53. In some embodiments, the tunnel box may be secured between the cab of a truck and the flat bed or bed of a truck 3. As depicted in FIG. 11, some embodiments of the accessory box system 50 further comprise one or more additional boxes 54a which may be utilized to supplement the storage capacity of the tunnel box 53. In some embodiments, the tunnel box 53 may be comprised of a door 58, a locking apparatus 56 and a means for sealing the door 58 against the body of the box 53 comprising a C-channel 76 and/or a weather strip 74. In some embodiments, the C-channel and weather strip elements of a box become bias against the door 58 when the door 58 is in a closed position, such that the interior of the box is protected from rain, water and/or other hostile elements in the environment.

In some embodiments, the tunnel box 53 may further comprise an extended bar 86 and lighting system 88, which may provide additional illumination and notice to passing traffic that a truck is in operation.

In some embodiments, the tunnel box may be associated with additional boxes 54a-c. Both the tunnel box 53 and the additional boxes 54a-c may be comprised of a drawer 60 and doors 58. The drawers 60 of the tunnel box 53 and additional boxes 54a-c may be slideably connected to the interior of a box such that the drawer 60 may move out of the opening created by the open door 58 such that an operator would have the capacity to access easily the contents, equipment and/or accessories stored inside the drawer 60. In some embodiments, the slideable drawer 60 in the tunnel box 53 provides easy access to the contents of the tunnel box 53.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A motorcycle dolly comprising:
a cradle to hold a wheel of a motorcycle;
a stabilization bar system comprising:
a first stabilization bar coupled to the cradle;
a second stabilization bar coupled to the cradle; and
a wheel coupled to the dolly.

2. The dolly of claim 1, further comprising wheels attached to the stabilization bars.

3. The dolly of claim 1, further comprising a wheel attached to the cradle.

4. The dolly of claim 1, further comprising more than one wheel attached to the cradle.

5. The dolly of claim 1, further comprising an attachment device for securing the handlebars of a motorcycle to the dolly.

6. The dolly of claim 1, further comprising D-Ring for connecting the dolly to a winch system of a tow truck.

7. The dolly of claim 1 further comprising multiple D-Rings for connecting the dolly to a winch system of a tow truck.

8. A method for loading a motorcycle onto the bed of a tow truck utilizing only one operator comprising:
coupling a motorcycle to a tow dolly, wherein the coupling is comprises:
placing the front wheel of a motorcycle into a cradle of said tow dolly; and
coupling the handle bars of the motorcycle to a stabilization bar system of the tow dolly;
attaching a cable to a D-Ring coupled to the tow dolly system; and
pulling the tow dolly and affixed motorcycle onto the bed of a flatbed truck.

9. An accessory box system for attachment to a mobile device comprising:
a box;
a door;
a drawer slideably connected to the interior of said box; and
a fixed partitioned top shelf.

10. The system of claim 9, further comprising a chain/cable system for supporting the door when in an open position.

11. The accessory box system of claim 9, further comprising a locking means for holding the drawer in an open or closed position.

12. The system of claim 9, further comprising a locking apparatus for securing the door in a closed position.

13. The system of claim 9, further comprising a weather strip and a “C” shaped channel biased against the interior of the door when the door is in a closed position to seal out air and moisture.

14. The system of claim 9, further comprising a light.

15. The system of claim 9, further comprising attachment means.

16. A method for securely stowing and transporting accessories associated with tow truck operations comprising:
securing an accessory box system to the frame of a tow truck beneath the plane created by the bed of the flat bed tow truck;
placing accessories and tools in the partitioned compartments of the accessory box system;
slideably closing the drawers interior to the accessory box system;
closing the doors of the accessory box system;
and locking said doors in place with a locking means.

17. A method of securing items in an accessory box system comprising the steps of:
raising the flatbed of a tow truck to allow access to a fixed patrician top shelf which is attached to the frame of stowing accessories and tools into the partitioned top shelf,
lowering the tow truck bed to effectively close the top of the fixed patrician top shelf.
